(19) United States
(12) Patent Application Publication
(10) Pub. No.: US 2015/0292399 A1
(43) Pub. Date: Oct. 15, 2015

(54) Altering Engine Combustion Cycle Using Electric Motor-Driven Exhaust and Intake Air Pumps

(71) Applicant: Arnold Magnetic Technologies, Rochester, NY (US)

(72) Inventor: Larry Kubes, Indianapolis, IN (US)

(73) Assignee: Arnold Magnetic Technologies, Rochester, NY (US)

(21) Appl. No.: 14/253,449

(22) Filed: Apr. 15, 2014

(51) Int. Cl. F02B 39/16

(52) U.S. Cl. CPC F02B 39/16

(57) ABSTRACT

An engine system comprises a turbine connected to the engine to receive exhaust gas from an engine and a compressor, mechanically independent of the turbine, connected to the engine to supply intake air to the engine. The engine system further comprises an electric motor connected to the turbine to rotate the turbine and an electric motor connected to the compressor to rotate the compressor. The engine system further comprises a control module configured to vary a pressure of the exhaust gas exiting the engine by changing the rotational velocity of the turbine and to vary the pressure of the intake air by changing the rotational velocity of the compressor. Using the ability to change the rotation velocity of the compressor and the turbine to alter pressures in the intake and exhaust, respectively, the engine combustion cycle can be altered to achieve a variety of operating conditions.

### BACKGROUND

The subject invention relates to engine systems and, more specifically, to altering the combustion cycle of an internal combustion engine using one or both of an exhaust gas pump and an intake air pump each driven by an electric motor.

Manipulating the combustion cycle of internal combustion engines has become increasingly important. In doing so, more efficient combustion of the fuel by enhanced control of the combustion cycle will result in increased power output and lower emissions from the engines.

Conventional turbochargers do an exemplary job of improving the combustion cycle of an internal combustion engine by increasing the intake air charge pressure, which delivers more air into the combustion chamber to increase the power output of the engine. Turbochargers therefore allow for smaller engine sizes to produce as much power and torque as larger engines do. Benefits that result from engine downsizing with turbochargers include idling fuel consumption reductions (e.g., when a vehicle is stopped at stoplights) while still maintaining sufficient power to the vehicle to operate the accessories such as air conditioning compressors and power steering pumps and maintaining good vehicle performance.

For these benefits, engine downsizing with turbocharging has become very commonplace in the automotive industry. In the current state of the art, turbochargers use a turbine mounted in the exhaust stream to capture the exhaust flow's inertial and heat energy to turn a shaft that is coupled to a compressor that drives more air into the engine combustion chamber.

In addition to using turbochargers, there have been other approaches to manipulate the combustion cycle of an internal combustion engine. These approaches include, among others, (1) modifying valve trains to change the operation of the valves, (2) modifying valve sizes and locations to alter in-cylinder airflow strategies, (3) using exhaust gas recirculation (EGR) to increase or decrease diluents in the combustion charge, and (4) using high pressure direct fuel injection.

The aforementioned approaches, including use of the conventional turbochargers, are not capable of easily altering the quantity of air and the exhaust gas in and out of the combustion chamber, which would provide further benefits. Therefore, it is desirable to provide methods and systems that easily alter the quantity of air and exhaust gas in and out of the combustion chamber.

### SUMMARY OF THE INVENTION

In one exemplary embodiment of the invention, an engine system that comprises an internal combustion engine is provided. The engine system further comprises a turbine connected to the engine to receive exhaust gas from the engine. The engine system further comprises a compressor, mechanically independent of the turbine, connected to the engine to supply intake air to the engine. The engine system further comprises an electric motor connected to the turbine to rotate the turbine. The engine system further comprises a control module configured to vary a pressure of the exhaust gas exiting the engine by adjusting a rotational velocity of the turbine using the electric motor.

In another exemplary embodiment of the invention, a method of controlling an engine system that comprises an internal combustion engine, a turbine connected to the engine to receive exhaust gas exiting the engine, and an electric motor connected to the turbine to rotate the turbine is provided. The method determines an amount of a pressure change by which to vary a pressure of the exhaust gas exiting the engine. Based on the determined amount of the pressure change, the method adjusts a rotational velocity of the turbine using the electric motor.

In yet another exemplary embodiment of the invention, an engine system comprising an internal combustion engine is provided. The engine system further comprises a compressor connected to the engine to supply an intake air to the engine. The engine system further comprises an electric motor connected to the compressor to rotate the compressor. The engine system further comprises a control module configured to vary a pressure of the intake air entering the engine by adjusting a rotational velocity of the compressor using the electric motor.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 illustrates an engine system that includes an engine of which the pressure in a chamber may be altered by a compressor driven by an electric motor and/or by a turbine driven by an electric motor in accordance with exemplary embodiments of the invention;

FIG. 2 illustrates an engine system when an engine is operating at the intake stroke in accordance with exemplary embodiments of the invention;

FIG. 3 illustrates a graph showing pressure change during combustion cycles of engines in accordance with exemplary embodiments of the invention;

FIG. 4 is a flowchart illustrating a method for controlling a compressor using an electric motor connected to a compressor in accordance with exemplary embodiments of the invention;

FIG. 5 illustrates an engine system when an engine is in transition from the expansion stroke to the intake stroke in accordance with exemplary embodiments of the invention;

FIG. 6 is a flowchart illustrating a method for varying the pressure in a chamber of an engine by controlling a compressor and/or a turbine each driven by an electric motor in accordance with exemplary embodiments of the invention;

FIG. 7 illustrates an engine system when an engine is a homogeneous charge compression ignition engine in accordance with exemplary embodiments of the invention;

FIG. 8 is a flowchart illustrating a method for controlling a quantity of unstable air-fuel molecules remaining in a chamber using a compressor and/or a turbine driven by electric motors in accordance with exemplary embodiments of the invention;

FIG. 9 illustrates an engine system that controls a quantity of exhaust gas remaining in a chamber of an engine to recycle the exhaust gas without using an Exhaust Gas Recirculation (EGR) valve in accordance with exemplary embodiments of the invention;

FIG. 10 is a flowchart illustrating a method for controlling a quantity of exhaust gas remaining in a chamber using a compressor and/or a turbine driven by electric motors in accordance with exemplary embodiments of the invention; and

FIG. 11 is a chart representative of various modes of engine operation embodying feature of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

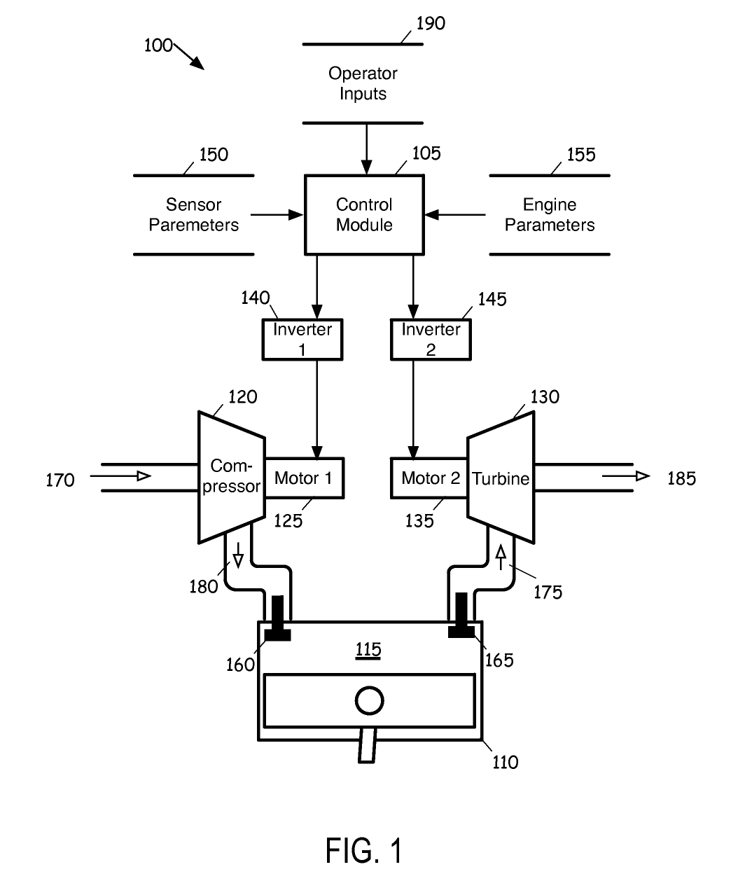

In accordance with an exemplary embodiment of the invention, FIG. 1 illustrates an engine system 100 that includes an engine 110 of which the pressure in a chamber 115 may be altered by a compressor 120 driven by a first electric motor 125, and/or by a turbine 130 driven by a second electric motor 135.

The compressor 120 takes in air 170 at an atmospheric pressure, compresses the air, and supplies the compressed air 180 to the engine 110. In an embodiment, the compressor 120 is driven by the first electric motor 125 rather than a shaft connected to a turbine at the exhaust side of the engine as is a conventional compressor of a turbocharger. Because the compressor 120 is driven by an electric motor rather than a shaft, the compressor 120 may vary or adjust pressure or create a vacuum at the inlet or the outlet of the compressor 120 by varying or adjusting the velocity and/or direction of its rotation. Specifically, the compressor 120 can vary or adjust the pressure in the chamber 115 by speeding up or slowing down the intake air stream to the chamber 115, or even reversing the direction of the intake air stream away from the chamber 115, by varying or adjusting the velocity and/or direction of the compressor's rotation. Moreover, being driven by an electric motor rather than a shaft, the compressor 120 can reduce or eliminate the turbo lag by increasing the rotational velocity rapidly. As used herein, it will be understood that the compressor 120 being “driven” by an electric motor means that the electric motor rotates an impeller (not shown) within a housing of the compressor 120.

In an embodiment, the first electric motor 125 that drives the compressor 120 is driven by a first inverter 140. The first inverter 140 is designed to drive the first electric motor 125 in both clockwise and counterclockwise directions (i.e., both rotational directions) precisely at particular rotational velocities ranging from zero to over 100,000 rotations per minute (RPM). The first inverter 140 is also designed to change the rotational velocity and direction of the first electric motor 125 rapidly.

The intake air 170 is supplied into the chamber 115 of the engine 110, which uses the air to combust fuel in order to create torque. The engine 110 may be of any engine type including, but not limited to, a diesel engine, a gasoline (also known as benzene or petrol, depending on the area of the world) direct injection engine, a homogeneous charge compression ignition (HCCI) engine, or other engine type. For simplicity of illustration and description, not all components of the engine 110 are depicted in FIG. 1. For instance, a fuel injector, a spark plug, an air/fuel mixer, etc. that the engine 110 may or may not have depending on the engine type are not depicted in FIG. 1. The engine 110 may be a two-stroke engine or a four-stroke engine.

The engine 110 produces exhaust gas 175 and the exhaust gas exits the chamber 115 into the turbine 130. The exhaust gas that passes through the turbine 130 (the exhaust gas to ambient 185) may enter an exhaust gas treatment system (not shown) and eventually out of the vehicle into the ambient air.

The turbine 130 is driven by the exhaust gas stream from the chamber 115 of the engine 110. However, unlike a turbine of a conventional turbocharger, the turbine 130 of an embodiment does not drive a compressor via a shaft that connects to a compressor. Instead, the turbine 130 is connected to the second electric motor 135, which drives the turbine 130. Because the turbine 130 is also driven by an electric motor in addition to the exhaust gas from the engine 110, the turbine 130 may vary pressure or create a vacuum at the inlet or the outlet of the turbine 130 by varying the velocity and/or direction of its rotation. Specifically, the turbine 130 can vary the pressure in the chamber 115 by speeding up or slowing down the exhaust stream from the chamber 115, or even reversing the direction of the exhaust stream to the chamber 115, by varying the velocity and/or direction of the compressor 120's rotation. Moreover, by not having to drive the compressor 120 via a shaft, the turbine 130 can also be connected to a generator (not shown) to generate electrical power from the exhaust heat recovery. In an embodiment, this energy may be used to drive the compressor 120, charge a battery, or drive other electrical loads on the vehicle, including electric traction motors that are mounted to the vehicle transmission or driveline. As used herein, it will be understood that the turbine 130 being “driven” by an electric motor means that the electric motor rotates a turbine wheel (not shown) within a housing of the turbine 130. Also, it is the turbine wheel that drives the generator.

In an embodiment, the second electric motor 135 is similar to the first electric motor 125 in that the second electric motor 135 drives the turbine 130 and is driven by a second inverter 145. The second inverter 145, like the first inverter 140, is designed to drive the second electric motor 135 in both clockwise and counterclockwise directions precisely at particular rotational velocities ranging from zero to over 100,000 rotations per minute (RPM). The inverter 145 is also designed to rapidly change the rotational velocity and direction of the second electric motor 135.

Being driven by the electric motors controlled by the inverters rather than being mechanically driven by a shaft or the exhaust gas, the compressor 120 and the turbine 130 broaden the operational capacity of the engine 110. The compressor 120 may vary its rotational velocity in such a way that a mechanically driven compressor cannot. For example, the compressor 120 may decrease the rotational velocity or even reverse the rotational direction of the compressor 120 to reduce the pressure in the chamber 115 or create a vacuum in the chamber 115. In doing so, the compressor 120 may also reverse the direction of the intake air flow away from the chamber 115. Moreover, the compressor 120 can also speed up to a rotational velocity that is beyond the velocity range of a turbine driven compressor.

Likewise, the turbine 130 may vary its rotational velocity beyond a range of typical mechanical turbines. For example, the turbine 130 may decrease or even reverse its rotational direction to increase the pressure in the chamber 115 or to create a backpressure near the outlet of the chamber 115. In doing so, the turbine 130 may also reverse the direction of the exhaust gas flow back to the chamber 115. Moreover, the turbine 130 can also speed up to a rotational velocity that is beyond the velocity range of a turbine driven by exhaust gas stream exiting the chamber.

A control module 105 controls the electric motors 125 and 135, and thereby controls the compressor 120 and the turbine 130, respectively. Different embodiments of the control module 105 controls the electric motors 125 and 135 by sending different types of control commands to the inverters 140 and 145 based on the types of motors to which the electric motors 125 and 135 belong. The types of motors may include permanent magnet motors, servo motors, series motors, separately excited motors, alternating current motors, or any other motor types that are capable of driving the turbines at speeds from zero to over 100,000 RPM. That is, the control commands that the control module 105 may send to the inverters 140 and 145 include voltage commands, current commands, frequency commands, etc. that are suitable to drive the different types of motors. As a specific example of control commands, the control module 105 in an embodiment generates voltage commands that specify the voltages that the inverters 140 and 145 are to supply to the electric motors 125 and 135, respectively, at appropriate instances in time. The control module 105 sends the voltage commands to the inverters 140 and 145.

In an embodiment, the control module 105 generates the voltage commands based one or more engine parameters 155, one or more operator inputs 190, and/or one or more sensor parameters 150 received from different sensor(s) (not shown). The engine parameters may include the lift and duration of camshafts (not shown), the configuration of a crankshaft (not shown), the volume of the chamber, and numerous other parameters of the engine that may be relevant in calculation of the voltage commands. In an embodiment, the engine parameter values are predefined or pre-calculated values. Alternatively or conjunctively, in an embodiment, the engine parameter values are dynamically calculated based on the sensor parameter values supplied by the sensors (not shown).

The sensors may include a chamber pressure sensor, an intake air pressure sensor, an intake air velocity sensor, an exhaust gas pressure sensor, an exhaust gas velocity sensor, a vehicle load sensor, and numerous other sensors that sense parameter values relevant in the calculation of the voltage commands. The sensors may be located at different locations of the engine system or a vehicle that includes the engine system. In an embodiment, the sensors supply the sensed parameter values to the control module 105 via a Controller Area Network (CAN).

The operator inputs 190 may include a throttle pedal input, a brake pedal input etc. that come from the vehicle operator's operative actions—e.g., applying brakes and adjusting pressure on the throttle pedal. Normally, the control module 105, upon receiving a brake pedal input indicating that the operator is applying the brake, slows down the compressor 120 and/or the turbine 130. It is to be noted that the control module 105 may slow down the compressor 120 and/or the turbine 130 based on a throttle pedal input without receiving a brake pedal input. That is, when the throttle pedal input indicates that the operator has reduced pressure on the throttle pedal or release the pedal, the control module 105 may command the compressor 120 and/or the turbine 130 to slow down.

While FIG. 1 illustrates an exemplary embodiment of the engine system 100 that has one compressor 120 and one turbine 130, different embodiments of the engine system 100 may have different number of compressors and turbines driven by electric motors. For instance, the engine system 100 may have more than one electric motor-driven compressor and/or more than one electric motor-driven turbine. Moreover, the number of such compressors and turbines need not be equal in number. For example, in an eight-cylinder (V8) engine, there may be two electric motor-driven turbines on two exhaust manifolds, and one electric motor-driven compressor on the intake manifold.

It is also to be noted that the rotational axis of the turbine 130 and the rotational axis of the compressor 120 need not be in parallel because the turbine 130 does not drive the compressor 120 unlike a conventional turbine in a conventional turbocharger does. That is, driving the turbine 130 and the compressor 120 using separate electric motors allows the rotational axes of the turbine 130 and the compressor 120 to be at any angle or orientation; allowing greater design options as to the placement of the compressor and the turbine with respect to the engine.

A conventional four-stroke engine uses camshaft(s) that have lobes that “lift” the valve off the valve seats in the chamber (i.e., cylinder) head to allow air and exhaust gas to flow into and out of the combustion chamber. The lobes of the camshaft(s) are oriented on the camshaft in a specific orientation to deliver good performance and emissions. Variable Valve Timing (VVT) strategies allow the camshaft lobe position and/or a lift to be altered slightly to improve performance and emissions in additional engine operating regimes that differ from the fixed position lobe setting. A relevant aspect of a VVT operation is that it typically allows for changing camshaft lobe positions between two, or limited settings only.

In a four-stroke engine, the expansion stroke drives the piston to bottom dead center (BDC) and causes the crankshaft to turn and produce torque. As the piston approaches BDC, the exhaust valve(s) opens and allows the spent gases to escape. As the piston moves up towards top dead center (TDC), the piston drives the spent gases from the chamber through the exhaust valve(s). At or near TDC, the intake valve(s) opens and the exhaust valve(s) closes. As the piston moves BDC, a vacuum is created in the chamber which causes the intake air charge to enter the chamber. As the piston approaches BDC, the intake valve(s) closes, trapping the intake charge in the chamber. Following the intake valve(s) closing, the piston compresses the intake charge by moving towards TDC. As the intake charge is compressed, at or near TDC, the charge becomes unsteady and combusts, in the case of diesel engines, or is caused to combust with the help of a spark plug firing in Otto type engines. This combustion cycle occurs several hundred times per minute in large diesel engines and several thousand times per minute in high performance racing engines. An aspect to note with a four-stroke engine is that the crankshaft turns two complete revolutions per one combustion cycle.

Many four-stroke engines are designed to have a period of time referred to as a valve overlap at the end of the exhaust stroke. During a valve overlap, both the intake and exhaust valves are open. The intake valve is opened before the exhaust gas completely exits the cylinder so that the intake charge is drawn in to the chamber as the exhaust gas exits the chamber. The exhaust valve closes just as the intake charge from the intake valve reaches in the chamber, to prevent either loss of the fresh charge or unscavenged exhaust gas. Having a long valve overlap assists the intake charge to enter the chamber and thereby increases the engine's volumetric efficiency. However, a long valve overlap reduces the efficiency and increases exhaust emissions of the engine when the engine is idling or at low RPMs. This is because at low RPMs the unburned intake charge flows freely through the engine intake and exhaust valves, which may result in high emissions.

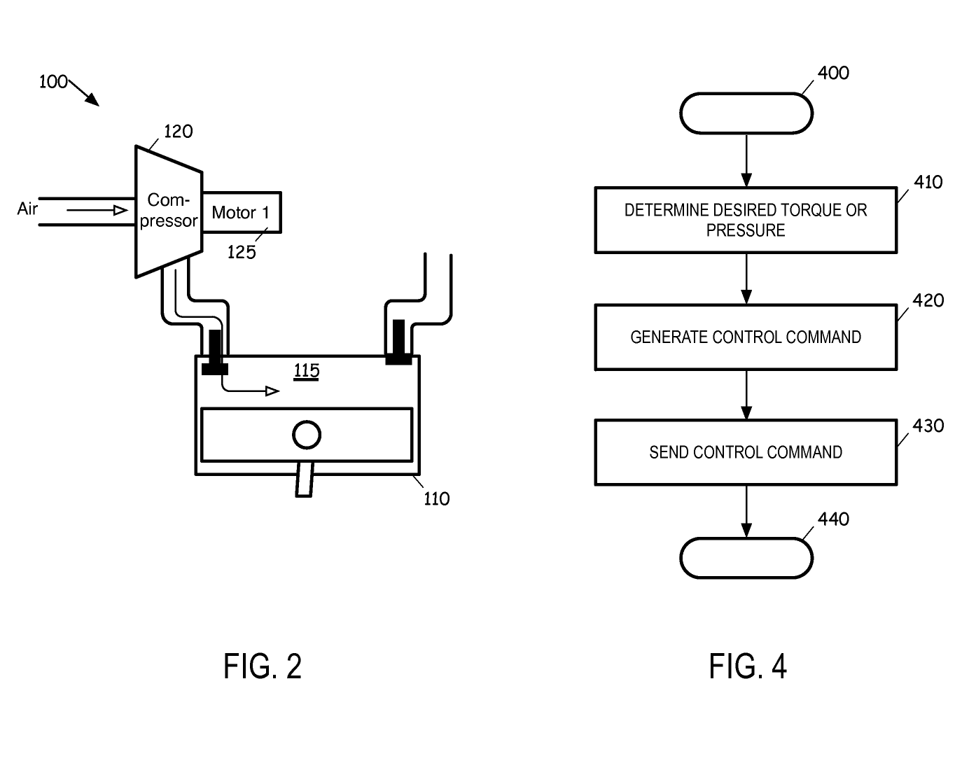

FIG. 2 illustrates the engine system 100 when the engine 110 is operating at the intake stroke according to exemplary embodiments of the invention. Specifically, FIG. 2 illustrates that the compressor 120 is supplying more air to the chamber 115 than a quantity of air that a naturally aspirated engine receives.

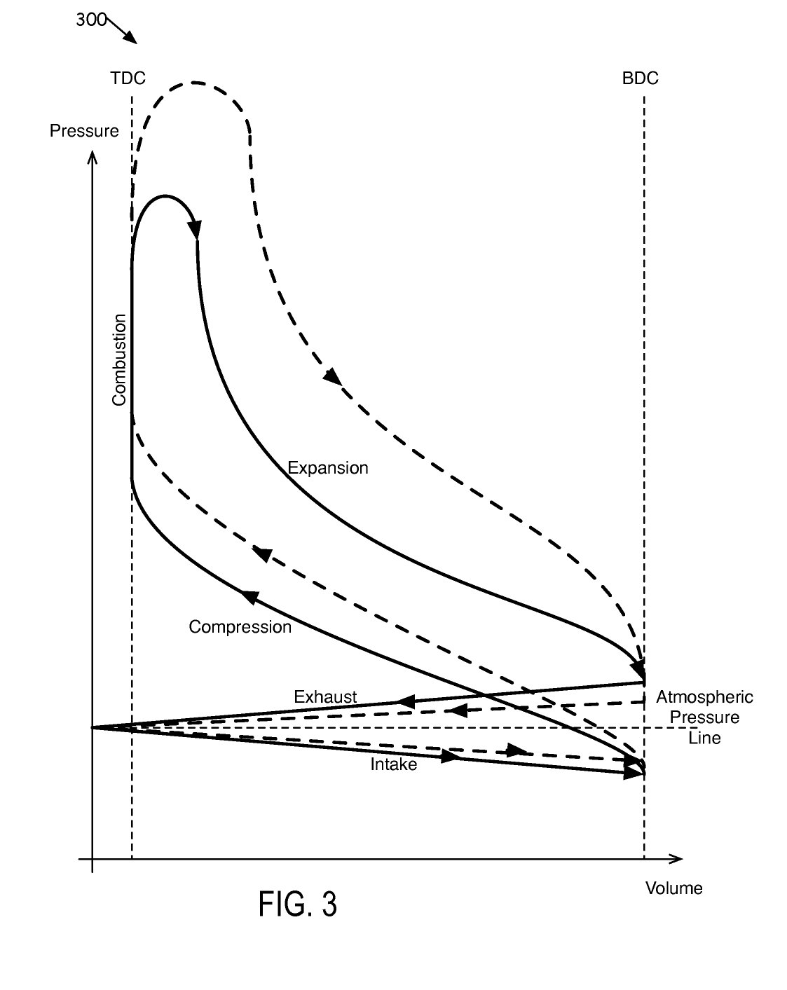

A four-stroke, naturally aspirated engine would operate according to the arrowed solid curve depicted in a graph 300 illustrated in FIG. 3. As shown, the x-axis of the graph represents varying volume of the chamber as the piston moves, and the y-axis of the graph represents pressure values. TDC and BDC are depicted as dotted vertical lines. The pressure values indicated by the arrowed solid curve are the result of the piston motion within the engine and combustion of the intake charge within the chamber of the engine. As can be seen from the arrowed solid curve in the graph, combustion occurs at TDC and results in a rapid increase in pressure.

With the help of the compressor 120 driven by the first electric motor 125, the engine 110 during the intake stroke takes in an increased mass of intake charge, which may include oxygen and fuel. As the increased mass of intake charge combusts after the compression stroke, a significantly higher combustion and expansion pressure is produced and this results in increased torque output of the engine 110. In this manner, the engine 110, with the compressor 120, produces greater power than a naturally aspirated engine. The arrowed dotted curve shown in the graph in FIG. 3 represents the pressure change in the engine 110 with the compressor 120. As shown, the pressure during the compression rises to a higher level, the pressure during the combustion is higher, and the pressure during the expansion is at a higher level. The area under the arrowed dotted curve is larger than the area under the arrowed solid curve. This indicates that the engine 110 with the compressor 120 produces more work output (i.e., torque) than the engine 110 without the compressor 120. Likewise, with the help of the turbine 130 driven by the second electric motor 135 during the exhaust stroke may extract the exhaust gas from the chamber faster or more completely.

Referring now to FIG. 4, and with continued reference to FIGS. 1 and 2, a flowchart illustrates a method for controlling a compressor using an electric motor connected to the compressor. In various embodiments, the method can be performed by the control module 105 of FIG. 1. In various embodiments, the method can be scheduled to run based on predetermined events, and/or run continually during operation of the engine system 100.

In one example, the method may begin at block 400. At block 410, the control module 105 determines a desired quantity of torque that the engine 110 is to produce for a combustion cycle. In an embodiment, the desired quantity of torque to produce is predefined and stored in a memory which the control module 105 accesses. Alternatively or conjunctively, the control module 105 may use the engine parameters 155 and/or the sensor parameters 150 to compute the desired quantity of torque.

At block 420, the control module 105 generates a control command. As a specific example of the control command, the control module 105 generates at block 420 a voltage command that specifies the voltage that the inverter 140 is to supply to the first electric motor 125 at appropriate instances in time. In an embodiment, the control module 105 uses the engine parameters 155, the sensor parameters 150, and/or the desired quantity of torque determined at block 410 to generate the voltage command.

At block 430, the control module 105 sends the control command generated at block 420 to the inverter 140. According to the control command (e.g., the voltage command), the inverter 140 gets voltage from a voltage source such as a battery (not shown in FIGS. 1 and 2). The inverter 140 then drives the first electric motor 125 by sending the processed voltage to the first electric motor 125. The first electric motor 125 rotates the compressor 120, and the compressor increases the chamber pressure during the intake stroke of the engine 110. The method ends at block 440.

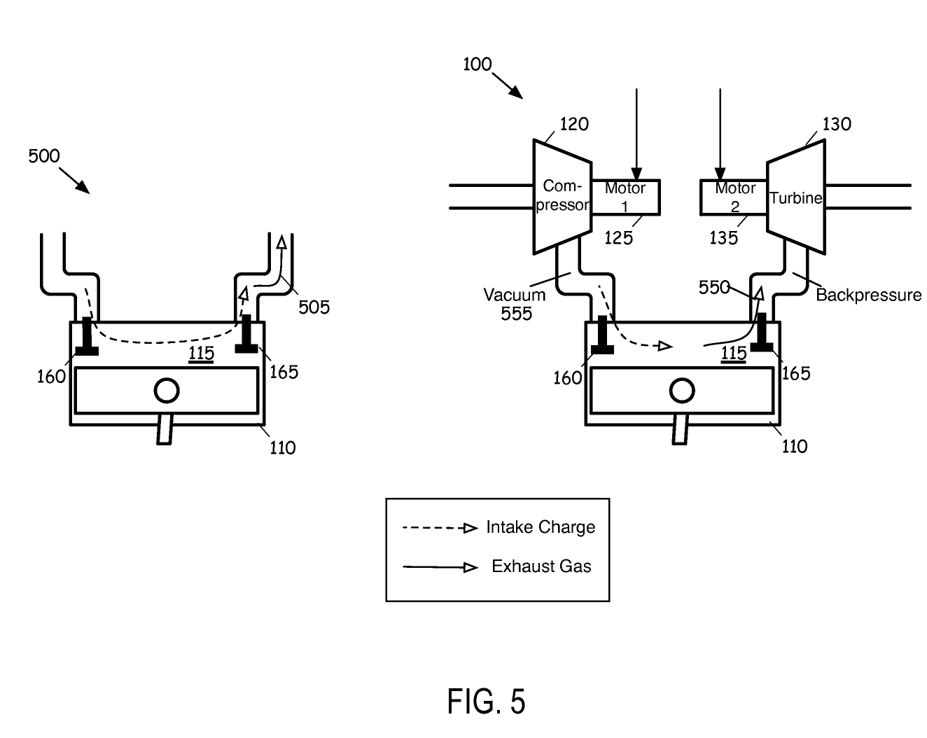

FIG. 5 illustrates the engine system 100 when the engine 110 is in transition from the expansion stroke to the intake stroke in accordance with exemplary embodiments of the invention. Specifically, FIG. 5 illustrates when the engine 110 is “scavenging”—i.e., the engine 110 is driving the exhaust gas out of chamber 115 of the engine 110 by opening the intake valve 160 before the exhaust valve 165 closes near the end of the exhaust cycle of the engine 110. For comparison purposes, an engine system 500 shown in the left half of FIG. 5 does not have the compressor 120 and the turbine 130 while the engine system 100 shown in the right half of FIG. 5 has the compressor 120 and/or the turbine 130.

The operational aspect of the engine 110, which the compressor 120 and the turbine 130 can significantly affect, is when the engine 110 operates at a low engine speed. Particularly, the compressor 120 and the turbo 130 may help address an issue that arises when the intake valve 160 and the exhaust valve 165 are opened with low lifts while the engine operates at a low engine speed. As discussed above, a duration of time during which both the intake valve and the exhaust valve are opened is referred to as a valve overlap. Generally, longer valve overlap helps the engine to produce more power at high engine speeds because the exhaust gas 505 exiting the chamber 115 lowers the pressure in the chamber, which encourages more intake charge to enter the engine. At lower engine speeds, however, a longer valve overlap may cause a large quantity of unburned fuel-air mixture to flow directly through the chamber 115, and into the exhaust stream 505 as shown by the engine system 500. This results in a large quantity of hydrocarbons in the exhaust stream, which is detrimental to emissions compliance, to the performance of the engine, and to fuel economy. This “flow through” may be more pronounced in high performance engines (e.g., race car engines), which typically have camshafts configured to have a very long overlap between the intake and exhaust cams.

In an embodiment, the exhaust gas stream is slowed by reducing the rotational velocity of the turbine 130. As shown in the right half of FIG. 5, reducing the rotational velocity of the turbine 130 causes an increase in the exhaust backpressure. The increased backpressure reduces the quantity of the exhaust gas 550 that escapes the chamber 115 but also prevents the intake charge from flowing through and out of the chamber 115 with the exhaust gas. In this manner, the turbine 130 driven by the second electric motor 135 improves the fuel economy of the engine 110 and improves emissions at low engine speeds in engines with a long valve overlap.

In an embodiment, the compressor 120 is operated in a manner that assists an engine 110 with a long valve overlap at low engine speeds. For instance, the rotational velocity of the compressor 120 may be reduced to induce a vacuum 555 on the intake side of the engine 110 while the engine is scavenging the exhaust gas from the chamber. The vacuum aids in preventing the air-fuel charge from flowing through the chamber 115 and escaping the chamber 115 with exhaust gas 550.

From the description so far for FIG. 5, it is apparent that varying the rotational velocity of the compressor 120 and/or the turbine 130 can vary the pressure in the chamber 115 with respect to the atmospheric pressure, and thereby cause the engine 110 to consume less fuel during valve overlap. This results in an overall gain in performance of the engine 110.

It is to be noted that the compressor 120 may also minimize the chamber filling when the piston is at or near BDC by reducing the rotational velocity of the compressor 120. Moreover, as the exhaust valve closes and the piston travels up from BDC, the rotational velocity of the compressor 120 may be increased to force more air-fuel charge into the chamber 115.

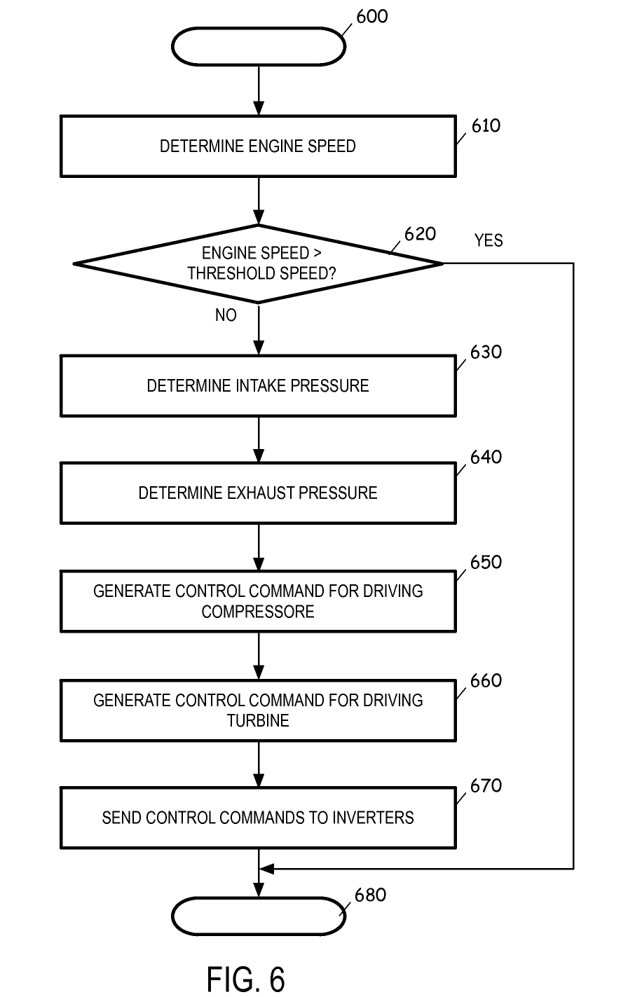

Referring now to FIG. 6, and with continuing reference to FIGS. 1 and 5, a flowchart illustrates a method for varying the pressure in a chamber of an engine by controlling a compressor and/or a turbine each driven by an electric motor. In various embodiments, the method can be performed by the control module 105 of FIG. 1. As can be appreciated in light of the present disclosure, the order of operation within the method is not limited to the sequential execution illustrated in FIG. 6, but may be performed in one or more varying orders as applicable and in accordance with the present disclosure. Also, not all of the operations defined by the blocks have to be performed in accordance with the present disclosure. In various embodiments, the method can be scheduled to run based on predetermined events, and/or run continually during operation of the engine system 100.

In one example, the method may begin at block 600. At block 610, the control module 105 determines the current speed of the engine 110. In an embodiment, the control module 105 determines the speed of the engine based on one or more sensor parameter values received from one or more sensors that monitor the engine speed. For instance, an engine speed sensor attached to the crankshaft of the engine 110 supplies the sensed speed value of the engine 110 to the control module 105.

At block 620, the control module 105 determines whether the engine speed determined at the block 610 exceeds a threshold speed. In an embodiment, this threshold speed is used to indicate whether the engine is operating at a low or high speed. In an embodiment, more than one threshold speed value may be used to define different ranges of the engine speed. The control module 105 may apply different control strategies based on the speed range in which the current engine speed falls. The threshold speed value(s) may be predefined or dynamically determined.

Based on determining at block 620 that the current engine speed exceeds a threshold speed, the method ends at 680. Based on determining at block 620 that the current engine speed does not exceed a threshold speed, the control module 105 at block 630 determines the intake air pressure near or at the inlet of the chamber 115 of the engine 110. In an embodiment, the control module 105 determines the intake air pressure based one or more sensor parameter values 150 received from one or more sensors that monitor the intake air pressure. Alternatively or conjunctively, the control module 105 derives the intake air pressure based on one or more other sensor parameter values. For instance, the control module 105 may derive the intake air pressure based on the current rotational velocity of the compressor 120.

Similarly, the control module 105 at block 640 determines the exhaust gas pressure near or at the outlet of the chamber of the engine 110. In an embodiment, the control module 105 determines the exhaust gas pressure based one or more sensor parameter values received from one or more sensors that monitor the exhaust gas pressure. Alternatively or conjunctively, the control module 105 derives the exhaust gas pressure based on one or more other sensor parameter values. For instance, the control module 105 may derive the exhaust pressure based on the current rotational velocity of the turbine 130.

At block 650, the control module 105 generates a control command. For example, the control module 105 may generate at block 650 a voltage command that specifies the voltage that the first inverter 140 is to supply to the first electric motor 125 at appropriate instances in time (e.g., during valve overlap). In an embodiment, the control module 105 uses one or more of the engine parameters 155, the sensor parameters 150, and the intake air pressure value determined at block 630 to generate the voltage command.

Similarly, the control module 105 generates at block 660 a control command (e.g., a voltage command) that specifies the voltage the second inverter 145 is to supply to the second electric motor 135 at appropriate instances in time (e.g., during valve overlap). In an embodiment, the control module 105 uses one or more of the engine parameters 155, the sensor parameters 150, and the exhaust pressure value determined at block 640 to generate the voltage command.

At block 670, the control module 105 sends the control commands generated at blocks 650 and 660 to the inverters 140 and 145, respectively. The inverters 140 and 145 each receive voltage from a voltage source (not shown in FIGS. 1 and 5) and process the voltage according to the control commands. The inverters 140 and 145 then drive the electric motors 125 and 135 by sending the processed voltage to the electric motors 125 and 135, respectively. The electric motors 125 and 135 rotate the compressor 120 and the turbine 130, respectively. The compressor 120 adjusts (e.g., reduces) the intake air pressure, and the turbine 130 adjusts (e.g., increases) the exhaust gas pressure (e.g., backpressure) accordingly. It is to be noted that, in an embodiment, the control module 105 may cause only one of the compressor 120 and the turbine 130 to operate to prevent the air-fuel charge from flowing through the chamber 115 and escaping the chamber without being combusted during valve overlap of the engine 110. The method ends at block 680.

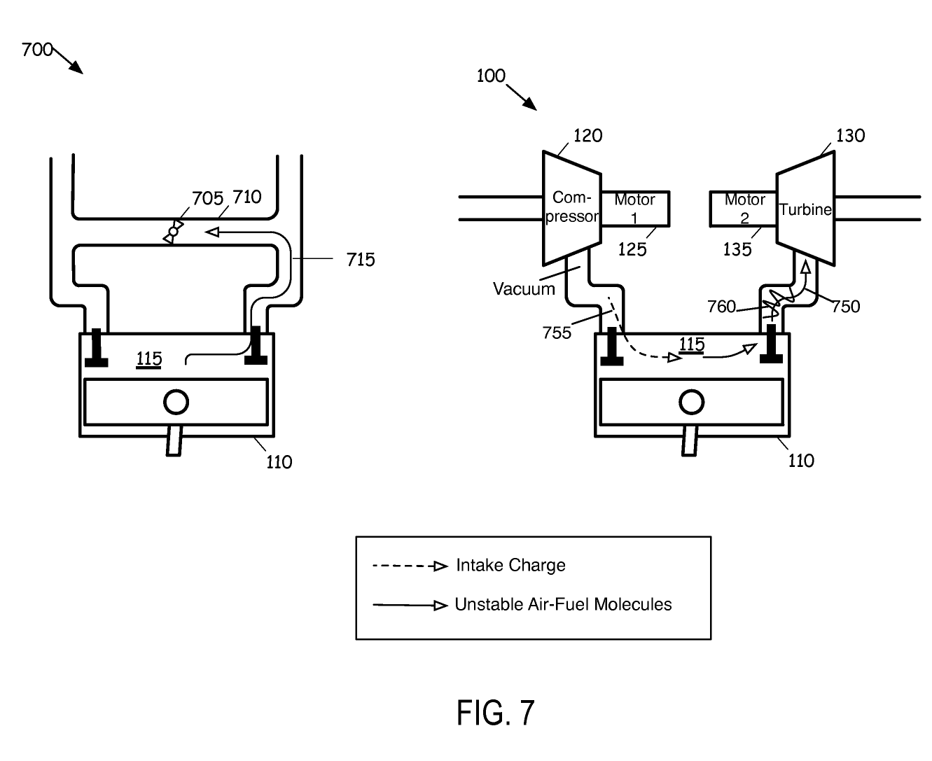

FIG. 7 illustrates the engine system 100 when the engine 110 is a homogeneous charge compression ignition (HCCI) engine in accordance with exemplary embodiments of the invention. FIG. 7 illustrates controlling a quantity of unstable air-fuel molecules (UAFM's) remaining in the chamber 115 of the engine 110 so as to “recycle” the molecules during subsequent combustion events. For comparison purposes, an engine system 700 shown in the left half of FIG. 7 does not include a compressor or a turbine driven by electric motors. The engine system 100 shown in the right half of FIG. 7 comprises a compressor 120 and/or a turbine 130.

In a conventional HCCI engine, controlling the exhaust gas flow in order to recycle unburned, unstable air-fuel molecules is important. These recycled UAFM's are combined with the fresh intake charge. During the compression stroke, the UAFM's become more unstable, especially near the end of the compression stroke. The unstable molecules eventually combust. When combusting in a HCCI engine, the UAFM's are dispersed throughout the engine combustion chamber 115. Since UAFM's are dispersed throughout the combustion chamber, the combustion occurs throughout the combustion chamber 115 rather than in one location as with spark ignition engines. As a result, HCCI engines may produce lower exhaust emissions than other types of engines do.

As shown, the conventional HCCI engine system 700 controls UAFM's 715 using a valve 705 disposed in a recirculation passage 710 that redirects the exhaust gas containing the UAFM's to the chamber 115. That is, the engine system 700 controls the quantity of UAFM's recirculated to the chamber by controlling the valve 705.

In contrast, the engine system 100, shown in FIG. 7, controls the UAFM's by varying the exhaust gas pressure using the turbine 130. For example, with the second electric motor 135 driving the turbine 130, the quantity of UAFM's remaining in the chamber can be more precisely controlled. In an embodiment, the exhaust gas stream 750 containing the UAFM's is slowed by reducing the rotational velocity of the turbine 130. Reducing the rotational velocity of the turbine 130 causes an increase in the exhaust backpressure (i.e., lower positive exiting pressure) as depicted by the line 760. Conversely, the exhaust gas stream 750 containing the UAFM's is sped up by increasing the rotational velocity of the turbine 130. Increasing the rotational velocity of the turbine 130 causes a decrease in the exhaust backpressure and an increase in UAFM's exiting the chamber. By controlling the exhaust backpressure, the engine system 100 can control the quantity of the exhaust gas containing the UAFM's remaining in the chamber 115.

In an embodiment, a compressor 120 may also be used to control the quantity of UAFM's remaining in the chamber 115. For instance, the rotational velocity of the compressor 120 may be reduced to induce a vacuum on the intake air stream 755 while the engine is exhausting the UAFM's from the chamber. The vacuum causes a pressure drop at the inlet of the chamber 115. This pressure drop reduces the difference in pressure between the inlet and outlet of the chamber 115, preventing a desired quantity of exhaust gas 750 from exiting the chamber 115 through the outlet. Conversely, the rotational velocity of the compressor 120 may be increased to drive a desired quantity of the UAFM's out of the chamber.

One of ordinary skill in the art would recognize that numerous control strategies using the compressor 120 and the turbine 130 may be devised as there are numerous different combinations of the rotational velocities of the compressor 120 and the turbine 130 (i.e., by generating numerous different combinations of control commands) to maintain the same, desired quantity of UAFM's in the chamber 115. Also, it is possible to use only one of the compressor 120 and the turbine 130 to maintain the desired quantity of UAFM's in the chamber 115. Controlling conventional HCCI engines has been a major hurdle to more widespread commercialization. With the compressor 120 and the turbine 130 driven by the electric motors, HCCI combustion becomes much easier to control.

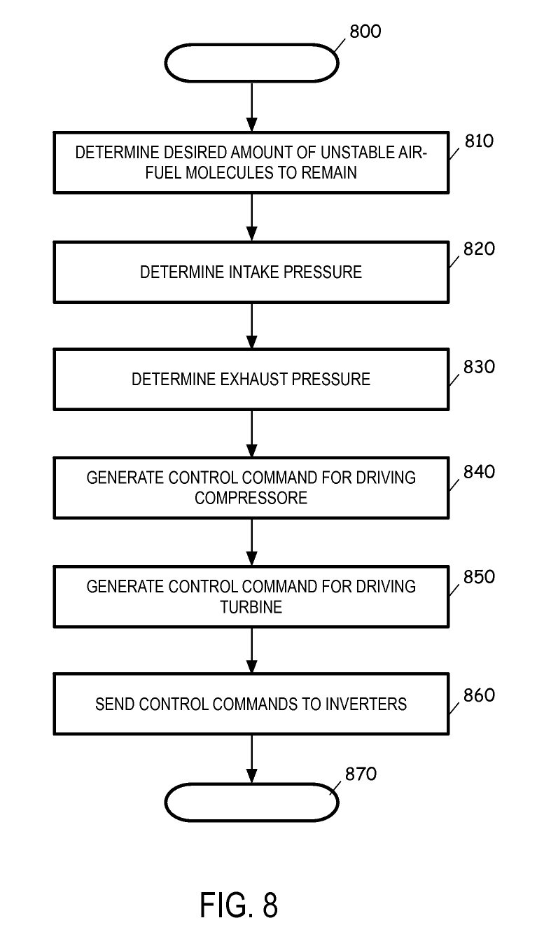

Referring now to FIG. 8, and with continuing reference to FIGS. 1 and 7, a flowchart illustrates a method for controlling a quantity of UAFM's remaining in a chamber using a compressor and/or a turbine driven by electric motors. In various embodiments, the method can be performed by the control module 105 of FIG. 1. As can be appreciated in light of the present disclosure, the order of operation within the method is not limited to the sequential execution as illustrated in FIG. 8, but may be performed in one or more varying orders as applicable and in accordance with the present disclosure. Also, not all of the operations defined have to be performed in accordance with the present disclosure. In various embodiments, the method can be scheduled to run based on predetermined events, and/or run continually during operation of the engine system 100.

In one example, the method may begin at block 800. At block 810, the control module 105 determines a desired quantity of UAFM's remaining in the chamber of the engine 110. In an embodiment, the control module 105 determines the desired quantity of UAFM's based on one or more of the engine parameters 155 and the sensor parameters 150. For instance, the control module 105 uses a quantity of exhaust gas generated, a quantity of UAFM's contained in the exhaust gas, a target quantity of torque to generate, etc. to determine the desired quantity of UAFM's. In an embodiment, the control module 105 computes the desired quantity of UAFM's. Alternatively or conjunctively, the control module 105 uses the desired quantity of UAFM's pre-calculated based on other predefined parameter values.

At block 820, the control module 105 determines the intake air pressure near or at the inlet of the chamber of the engine 110, similar to the operation defined by the block 630 described above by reference to FIG. 6. The control module 105 at block 830 determines the exhaust gas pressure near or at the outlet of the chamber of the engine 110, similar to the operation defined by the block 640.

At block 840, the control module 105 generates a control command. In an example of the control command, the control module 105 generates at block 840 a voltage command that specifies the voltage that the inverter 140 is to supply to the first electric motor 125 at appropriate instances in time (e.g., near the end of the exhaust stroke of the engine 110). In an embodiment, the control module 105 uses one or more of the engine parameters 155, the sensor parameters 150, and the intake air pressure value determined at block 820 to generate the control command.

Similarly, the control module 105 generates at block 850 a control command (e.g., a voltage command) that specifies the voltage the inverter 145 is to supply to the second electric motor 135 at appropriate instances in time (e.g., near the end of the exhaust stroke of the engine 110). In an embodiment, the control module 105 uses one or more of the engine parameters 155, the sensor parameters 150, and the exhaust pressure value determined at block 830 to generate the voltage command.

At block 860, the control module 105 sends the control commands generated at blocks 840 and 850 to the inverters 140 and 145, respectively. The inverters 140 and 145 each receive voltage from a voltage source (not shown in FIGS. 1 and 7) and process the voltage according to the control commands. The inverters 140 and 145 then drive the electric motors 125 and 135 by sending the processed voltage to the electric motors 125 and 135, respectively. The electric motors 125 and 135 rotate the compressor 120 and the turbine 130, respectively. The compressor 120 adjusts (e.g., reduces) the intake air pressure, and the turbine 130 adjusts (e.g., increases) the exhaust gas pressure (e.g., backpressure) accordingly. It is to be noted that, in an embodiment, the control module 105 may cause only one of the compressor 120 and the turbine 130 to maintain the desired quantity of UAFM's in the chamber. The method ends at block 870.

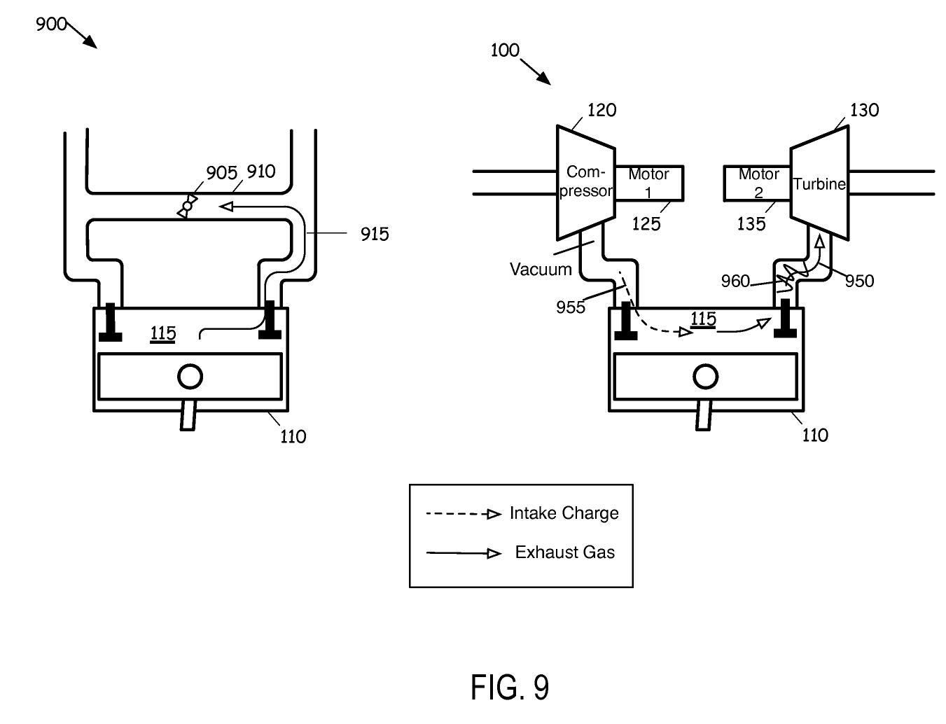

FIG. 9 illustrates an engine system 100 that controls a quantity of exhaust gas 950 to maintain in the chamber 115 of the engine 110 to recycle the exhaust gas without using an Exhaust Gas Recirculation (EGR) valve in accordance with exemplary embodiments of the invention. For exemplary purposes, engine system 900 shown in the left half of FIG. 9 does not have a compressor or a turbine driven by electric motors. The engine system 100 shown in the right half of FIG. 9 comprises a compressor 120 and/or a turbine 130.

Many conventional engines employ EGR to control the combustion cycle. The conventional engines that employ EGR recycle exhaust gases into the chamber similar to the way in which conventional HCCI engines recycle the exhaust gas containing UAFM's. However, compared to conventional HCCI engines, conventional EGR engines introduce a significantly larger quantity of exhaust gas into the chamber to moderate combustion pressure and temperature. Because combustion temperature is reduced by the recycled exhaust gas, a lower quantity of NOx is produced by these conventional EGR engines.

As shown, the engine system 900 controls exhaust gas 915 using a valve 905 disposed in a recirculation passage 910 that redirects the exhaust gas to the chamber 115. That is, the engine system 900 controls the quantity of exhaust gas to recycle to the chamber 115 by controlling the valve 905.

In contrast, the engine system 100, shown in FIG. 9, controls the exhaust gas 950 by varying the exhaust gas pressure using the turbine 130. With the second electric motor 135 driving the turbine 130, the quantity of exhaust gas remaining in the chamber can be more precisely controlled. In an embodiment, the exhaust gas stream is slowed down by reducing the rotational velocity of the turbine 130. Reducing the rotational velocity of the turbine 130 causes an increase in the exhaust backpressure (i.e., lower positive exiting pressure) as depicted by the line 960. Conversely, the exhaust gas stream is sped up by increasing the rotational velocity of the turbine 130. Increasing the rotational velocity of the turbine 130 causes a decrease in the exhaust backpressure and thus more exhaust gas will exit the chamber. By controlling the exhaust backpressure, the engine system 100 can control the quantity of the exhaust gas remaining in the chamber 115.

In an embodiment, the compressor 120 may also be used to control the quantity of exhaust gas remaining in the chamber. For instance, the rotational velocity of the compressor 120 may be reduced to induce a vacuum on the intake air stream while the engine is exhausting the chamber 115. The vacuum will cause a pressure drop at the inlet of the chamber. This pressure drop will reduce the difference in pressure between the inlet and outlet of the chamber, preventing a desired quantity of exhaust gas from leaving the chamber through the outlet. Conversely, the rotational velocity of the compressor 120 may be increased to drive a desired quantity of exhaust gas out of chamber 115.

One of ordinary skill in the art would recognize that numerous control strategies using the compressor 120 and the turbine 130 may be devised as there are numerous different combinations of the rotational velocities of the compressor 120 and the turbine 130 (i.e., by generating numerous different combinations of control commands) to maintain the same, desired quantity of exhaust gas in the chamber. Also, it is possible to use only one of the compressor 120 and the turbine 130 to maintain the desired quantity of exhaust gas in the chamber.

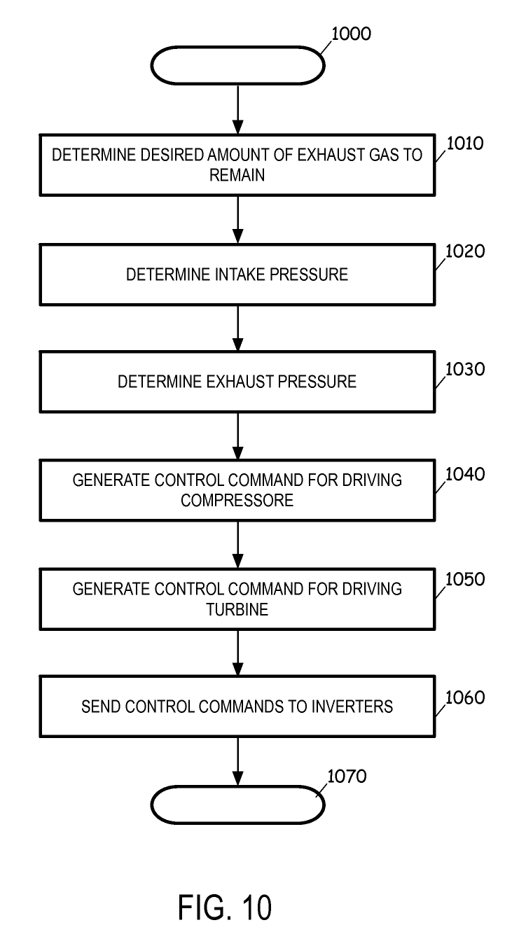

Referring now to FIG. 10, and with continuing reference to FIGS. 1 and 9, a flowchart illustrates a method for controlling a quantity of exhaust gas remaining in a chamber using a compressor and/or a turbine driven by electric motors. In various embodiments, the method can be performed by the control module 105 of FIG. 1. As can be appreciated in light of the present disclosure, the order of operation within the method is not limited to the sequential execution as illustrated in FIG. 10, but may be performed in one or more varying orders as applicable and in accordance with the present disclosure. Also, not all of the operations defined have to be performed in accordance with the present disclosure. In various embodiments, the method can be scheduled to run based on predetermined events, and/or run continually during operation of the engine system 100.

In one example, the method may begin at block 1000. At block 1010, the control module 105 determines a desired quantity of exhaust gas 950 remaining in the chamber 115 of the engine 110. In an embodiment, the control module 105 determines the desired quantity of exhaust gas based on one or more of the engine parameters 155 and the sensor parameters 150. For instance, the control module 105 uses a volume of exhaust gas generated, a quantity of relevant gas (e.g., NOx) contained in the exhaust gas, a target quantity of torque to generate, etc. to determine the desired quantity. In an embodiment, the control module 105 computes the desired quantity of exhaust gas. Alternatively or conjunctively, the control module 105 uses a desired quantity of exhaust gas that is predetermined based on other predefined parameter values.

At block 1020, the control module 105 determines the intake air pressure near or at the inlet of the chamber 115 of the engine 110, similar to the operation defined by the block 630 described above by reference to FIG. 6. The control module 105 at block 1030 determines the exhaust gas pressure near or at the outlet of the chamber of the engine 110, similar to the operation defined by the block 640.

At block 1040, the control module 105 generates a control command. In an example of the control command, the control module 105 generates a voltage command that specifies the voltage that the inverter 140 is to supply to the first electric motor 125 at appropriate instances in time (e.g., near the end of the exhaust stroke of the engine 110). In an embodiment, the control module 105 uses one or more of the engine parameters 155, the sensor parameters 150, and the intake air pressure value determined at block 1020 to generate the control command.

Similarly, the control module 105 generates at block 1050 a control command (e.g., a voltage command) that specifies the voltage the inverter 145 is to supply to the second electric motor 135 at appropriate instances in time (e.g., near the end of the exhaust stroke of the engine 110). In an embodiment, the control module 105 uses one or more of the engine parameters 155, the sensor parameters 150, and the exhaust pressure value determined at block 1030 to generate the control command.

At block 1060, the control module 105 sends the control commands generated at blocks 1040 and 1050 to the inverters 140 and 145. The inverters 140 and 145 each receive voltage from a voltage source (not shown in FIGS. 1 and 9) and process the voltage according to the control commands. The inverters 140 and 145 then drive the electric motors 125 and 135 by sending the processed voltage to the first electric motors 125 and 135, respectively. The electric motors 125 and 135 rotate the compressor 120 and the turbine 130, respectively. The compressor 120 adjusts (e.g., reduces) the intake air pressure, and the turbine 130 adjusts (e.g., increases) the exhaust gas pressure (e.g., backpressure) accordingly. It is to be noted that, in an embodiment, the control module 105 may cause only one of the compressor 120 and the turbine 130 to maintain the desired quantity of exhaust gas in the chamber. The method ends at block 1070.

The methods and systems of various embodiments of the invention described so far show only some of the possible control strategies. There are numerous other control strategies that could be realized by using the electronically controlled turbines and compressors. The turbine and the compressor of various embodiments of the invention provide the ability to not only increase or decrease exhaust gas flow and/or the intake air flow, but also to cause a reversal in the exhaust gas flow direction or the intake air flow direction. This ability to control the engine intake air flow and exhaust gas flow enables the engine designers to design engines that operate at such operating dimensions that have been previously unachievable.

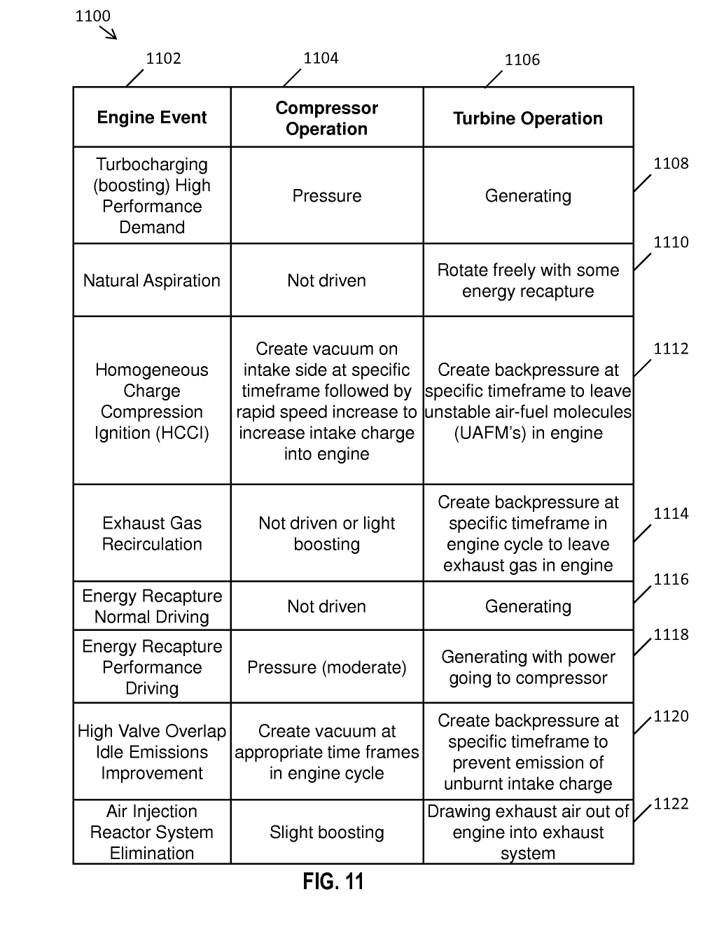

FIG. 11 illustrates a table 1100 that shows some example control strategies that can be realized by the electronically controlled turbines and compressors of the embodiments so far described in this disclosure. The table 1100 is intended only for demonstration purposes of typical system operations and is by no means inclusive of all the possible strategies. The first column 1102 of each row describes an objective of engine operation. The second column 1104 of each row describes a control strategy for a compressor (e.g., the compressor 120) of some embodiments of the invention to achieve the objective. The third column 1006 of each row describes a control strategy for a turbine (e.g., the turbine 130) of some embodiments of the invention to achieve the objective.

The objective described in row 1108 is turbocharging (i.e., “boosting”) the engine to meet high performance demand. For this objective, the compressor may be driven to create pressure on the intake side of the engine. The turbine may be used to drive the electric motor connected to the turbine to generate electrical power from the exhaust gas in high speed/pressure.

The objective described in row 1110 is natural aspiration. Thus, the compressor may not have to be driven to change the pressure on the intake side of the engine. The turbine can be rotated freely by the exhaust gas and may also drive the electric motor to recapture some of the energy carried by the exhaust gas.

The objective described in row 1112 is an HCCI engine operation. As described above by reference to FIG. 7, the compressor may be driven to create a vacuum on the intake side at a specific time frame to maintain a desired amount of UAFM in the engine. Subsequently, the compressor may be driven to increase the rotational speed rapidly to push intake charge into the engine. On the other hand, the turbine can be driven to create backpressure at a specific time frame to leave a desired amount of UAFM in the engine.

The objective described in row 1114 is exhaust gas recirculation. To achieve this objective, the compressor may not have to be driven to change the pressure on the intake side of the engine or may be driven to boost the engine lightly. The turbine can be driven to create backpressure at a specific time frame to maintain a desired amount of exhaust gas in the engine.

The objective described in row 1116 is energy recapturing under a normal driving condition. To achieve this objective, the compressor may not have to be driven to change the pressure on the intake side of the engine. The turbine is driven by the exhaust gas and in turn drives the electric motor attached to the turbine to generate electrical power.

The objective described in row 1118 is energy recapturing under a performance driving condition. To achieve this objective, the compressor may be driven to create a moderate pressure on the intake side of the engine. The turbine is driven by the exhaust gas and in turn drives the electric motor attached to the turbine to generate electrical power. Also, the generated electricity may be sent to the electric motor connected to the compressor to drive the compressor.

The objective described in row 1120 is improving emissions when an engine with a long valve overlap is idling. The compressor can be driven to increase the pressure or create a vacuum at appropriate time frames during an engine cycle. The turbine can be driven to create backpressure at a specific time frame to prevent unburnt intake charge from being emitted to the ambient air. It is to be noted that the compressor and the turbine can be driven to achieve this objective exclusively or driven to achieve other objectives together.

The objective described in row 1122 is to eliminate the need of an air injection reactor system. A typical air injection reactor system injects excess oxygen to a catalytic converter of the exhaust system to help the catalytic converter to reach its light-off temperature following engine cold-start. The system typically runs for a short time following engine cold-start to pump air to the catalytic converter. In order to achieve this objective, the compressor may be driven to push intake air into the engine to boost the engine slightly. The turbine may be driven to draw exhaust air out of the engine and deliver it to the exhaust system.

In the above description of each row of the table 1000, the compressor operation is described ahead of the description of the turbine operation. As can be recognized, that does not necessarily indicate that the turbine operation is occurring temporally after the operation of the compressor.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. An engine system comprising:
an internal combustion engine;
a turbine connected to the engine to receive exhaust gas from the engine;
a compressor, mechanically independent of the turbine, connected to the engine to supply intake air to the engine;
an electric motor connected to the turbine to rotate the turbine; and
a control module configured to vary a pressure of the exhaust gas exiting the engine by adjusting a rotational velocity of the turbine using the electric motor.

2. The engine system of claim 1,
wherein the control module is further configured to determine whether the engine is operating at a speed that is lower than a threshold speed,
wherein the control module is configured to vary the pressure of the exhaust gas based on determining that the engine is operating at the speed that is lower than the threshold speed.

3. The engine system of claim 1,
wherein the control module is further configured to determine whether the engine is operating in a valve overlap,
wherein the control module is configured to vary the pressure of the exhaust gas based on determining that the engine is operating in the valve overlap.

4. The engine system of claim 1, wherein the pressure of the exhaust gas increases when the rotational velocity of the turbine is reduced or reversed.

5. The engine system of claim 1, wherein the adjusting the rotational velocity of the turbine comprises one of slowing or reversing a rotational direction of the turbine using the electric motor.

6. The engine system of claim 1, wherein the control module is configured to vary the pressure of the exhaust gas by reversing a flow direction of the exhaust gas by reversing a rotational direction of the turbine using the electric motor.

7. The engine system of claim 1,
wherein the engine comprises a homogeneous charge compression ignition (HCCI) engine,
wherein the exhaust gas from the HCCI engine comprises unstable air-fuel molecules.

8. The engine system of claim 1,
wherein the control module is further configured to determine a quantity of the exhaust gas to remain in the engine,
wherein the control module is configured to vary the pressure of the exhaust gas based on the quantity of the exhaust gas to remain in the engine.

9. The engine system of claim 1, the engine system further comprising an electric motor connected to the compressor to rotate the compressor, wherein the control module is further configured to vary a pressure of the intake air entering the engine by adjusting a rotational velocity of the compressor using the electric motor connected to the compressor.

10. The engine system of claim 9,
wherein the control module is further configured to determine whether the engine is operating at a speed that is lower than a threshold speed,
wherein the control module is configured to vary the pressure of the intake air based on determining that the engine is operating at the speed that is lower than the threshold speed.

11. The engine system of claim 9,
wherein the control module is further configured to determine whether the engine is operating in a valve overlap,
wherein the control module is configured to vary the pressure of the intake air further based on determining that the engine is operating in the valve overlap.

12. The engine system of claim 9, wherein the pressure of the intake air decreases when the rotational velocity of the compressor is reduced or reversed.

13. The engine system of claim 9, wherein the control module is configured to vary the pressure of the intake air further by increasing the rotational velocity of the compressor using the electric motor connected to compressor.

14. The engine system of claim 9, wherein the adjusting the rotational velocity of the compressor comprises one of slowing or reversing a rotational direction of the compressor using the electric motor connected to the compressor.

15. The engine system of claim 9, wherein the control module is configured to vary the pressure of the intake air by reversing a flow direction of the intake air by reversing a rotational direction of the compressor into using the electric motor connected to the compressor.

16. The engine system of claim 9, wherein the adjusting the rotational velocity of the compressor comprises increasing the rotational velocity of the compressor using the electric motor connected to the compressor.

17. The engine system of claim 1, wherein the electric motor connected to the turbine is configured to be rotated by the turbine for generating electrical power.

18. The engine system of claim 1, wherein the adjusting the rotational velocity of the turbine comprises increasing the rotational velocity of the turbine using the electric motor.

19. A method of controlling an engine system that comprises an internal combustion engine, a turbine connected to the engine to receive exhaust gas exiting the engine, and an electric motor connected to the turbine to rotate the turbine, the method comprising:
determining an amount of a pressure change by which to vary a pressure of the exhaust gas exiting the engine; and
based on the determined amount of the pressure change, adjusting a rotational velocity of the turbine using the electric motor.

20. The method of claim 19, wherein the adjusting the rotational velocity of the turbine comprises one of slowing or reversing a rotational direction of the turbine using the electric motor.

21. The method of claim 19, wherein the adjusting the rotational velocity of the turbine comprises increasing the rotational velocity of the turbine using the electric motor.

22. An engine system comprising:
an internal combustion engine;
a compressor connected to the engine to supply an intake air to the engine;
an electric motor connected to the compressor to rotate the compressor; and
a control module configured to vary a pressure of the intake air entering the engine by adjusting a rotational velocity of the compressor using the electric motor.

23. The engine system of claim 22,
wherein the control module is further configured to determine whether the engine is operating in a valve overlap; and
wherein the control module is configured to vary the pressure of the intake air further based on determining that the engine is operating in the valve overlap.

24. The engine system of claim 23, wherein the adjusting the rotational velocity of the compressor comprises one of slowing or reversing a rotational direction of the compressor using the electric motor.

25. The engine system of claim 23, wherein the control module is configured to vary the pressure of the intake air by reversing a flow direction of the intake air by reversing a rotational direction of the compressor into an opposite direction using the electric motor.

26. The engine system of claim 22, wherein the adjusting the rotational velocity of the compressor comprises increasing the rotational velocity of the compressor using the electric motor.
